(19) United States
(12) Patent Application Publication
(10) Pub. No.: US 2023/0074515 A1
(43) Pub. Date: Mar. 9, 2023

(54) ELECTRICAL DEVICE

(71) Applicants: Inventec (Pudong) Technology Corporation, Shanghai (CN); INVENTEC CORPORATION, TAIPEI CITY (TW)

(72) Inventors: Chun Hao WANG, Taipei City (TW); Chien Chang CHEN, Taipei City (TW); Chia-Chen CHEN, Taipei City (TW); Chi-Zen PENG, Taipei City (TW)

(21) Appl. No.: 17/447,698

(22) Filed: Sep. 15, 2021

(30) Foreign Application Priority Data
Sep. 7, 2021 (CN) 202111045293.1

(51) Int. Cl. G06F 1/16; E05D 3/12

(52) U.S. Cl. CPC G06F 1/1681; E05D 3/122; G06F 1/1618

(57) ABSTRACT

An electrical device includes a base, a display screen, and a driving structure. The base having an upper shell and a lower shell, in which the upper shell is movably connected to the lower shell. The display screen is pivoted to and rotatably with respect to the base. The driving structure is connected to the display screen and partially disposed between the upper shell and the lower shell. The driving structure is configured for driving the upper shell to cover the lower shell to form a close state or separate from the lower shell to form an open state, so as to enable the base to switch between the close state and the open state.

### CROSS-REFERENCE TO RELATED APPLICATION

This application claims priority to China Application Serial Number 202111045293.1, filed Sep. 7, 2021, which is herein incorporated by reference in its entirety.

### BACKGROUND

### Field of Invention

The present invention relates to an electrical device. More particularly, the present invention relates to an electrical device with a transformation function.

### Description of Related Art

Electrical devices such as laptop have power suppliers for supplying power to electrical assemblies. Due to the operation of the internal electrical assemblies, such as controller, processor, and memory, the electrical devices generate a great amount of heat. The operation of the electrical devices will be stopped and interfered if the cooling efficiency is not enough. Fan modules are generally used to take the heat away from the electrical devices for dissipating the heat. Nevertheless, the heat dissipation efficiency is limited since the size and specification requirement of the electrical devices lead to the limitation of air flow paths.

Accordingly, research in various industries has been focused on ways to develop an electrical device with outstanding heat dissipation ability.

### SUMMARY

The invention provides an electrical device including a base, a display screen, and a driving structure. The base having an upper shell and a lower shell, in which the upper shell is movably connected to the lower shell. The display screen is pivoted to and rotatably with respect to the base. The driving structure is connected to the display screen and partially disposed between the upper shell and the lower shell. The driving structure is configured for driving the upper shell to cover the lower shell to form a close state or separate from the lower shell to form an open state, so as to enable the base to switch between the close state and the open state.

In some embodiments of the present invention, the driving structure including a gear assembly, a linkage assembly, and a pushing assembly. The gear assembly is connected to a rotating shaft of the display screen. The linkage assembly includes a moving rod and a rotating rod which is connected to the gear assembly, and the rotating rod is configured to rotate for driving the moving rod to move. The pushing assembly is connected to the moving rod, and the pushing assembly drives the upper shell to move toward the lower shell or move away from the lower shell when the moving rod is moving.

In some embodiments of the present invention, the driving structure includes a guiding assembly having a guiding slot, and the pushing assembly has an extension portion inserted into the guiding slot and connected to moving rod.

In some embodiments of the present invention, the guiding slot has a wavy-shaped portion.

In some embodiments of the present invention, the guiding slot has an inverted V-shaped middle portion.

In some embodiments of the present invention, the driving structure includes a guiding assembly having two parallel boards and two guiding slots, and the two guiding slots are respectively disposed at the two boards in mirror symmetry. The pushing assembly has an extension portion inserted into the guiding slots and connected to moving rod.

In some embodiments of the present invention, the pushing assembly is disposed between the two boards.

In some embodiments of the present invention, the gear assembly has at least three gears which are sequentially engaged, and the rotating shaft of the display screen and the rotating rod are respectively connected to two of the gears, such that the display screen and the rotating rod has a same rotating direction.

In some embodiments of the present invention, the base is in an open state and has an air flow path when the driving structure moves the upper shell to separate from the lower shell.

In some embodiments of the present invention, the base is in a closed state for closing the air flow path when the driving structure moves the upper shell to cover the lower shell.

In embodiments of the present invention, an electrical device includes a display screen and a base, and the display screen is rotatably with respect to the base and configured for driving the upper shell to separate from the lower shell or cover the lower shell. When the upper shell of the base is separated from the lower shell, the base has an air flow path. Therefore, the electrical device has outstanding heat dissipation ability. When the upper shell of the base covers the lower shell, the airflow path is closed to prevent the electrical device from affecting by dust.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a schematic view of a driving structure in accordance with some embodiments of the present invention;

FIG. 2 illustrates an internal view of a driving structure in accordance with some embodiments of this invention;

FIG. 3 illustrates a top view of a driving structure in accordance with some embodiments of this invention;

FIG. 4 illustrates a side view of a driving structure in accordance with some embodiments of this invention;

FIG. 5 illustrates a cross section view of the driving structure taken from the line 5-5 in FIG. 3;

FIGS. 6-8 illustrate schematic views of a driving structure in accordance with some embodiments, and the partial driving structure is shown as transparent; and

FIGS. 9-11 illustrate schematic views of an electrical device, and a base of the electrical device is partially neglected for exposing a driving structure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

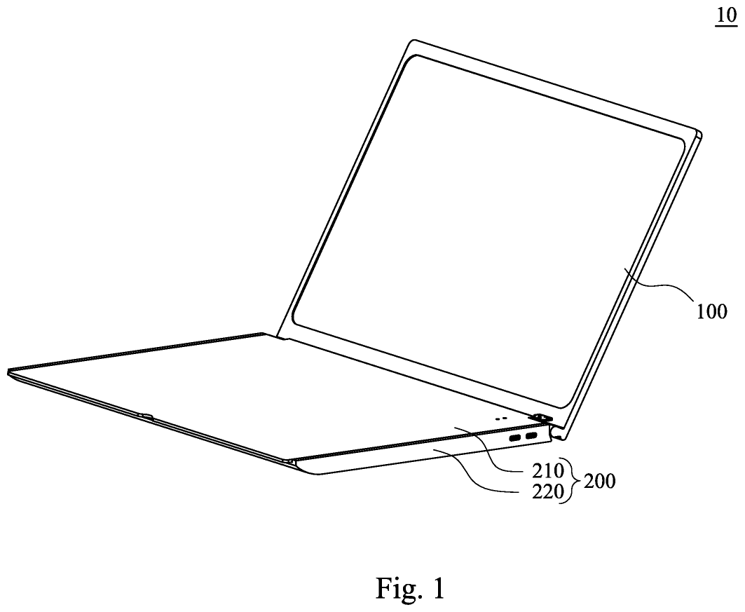

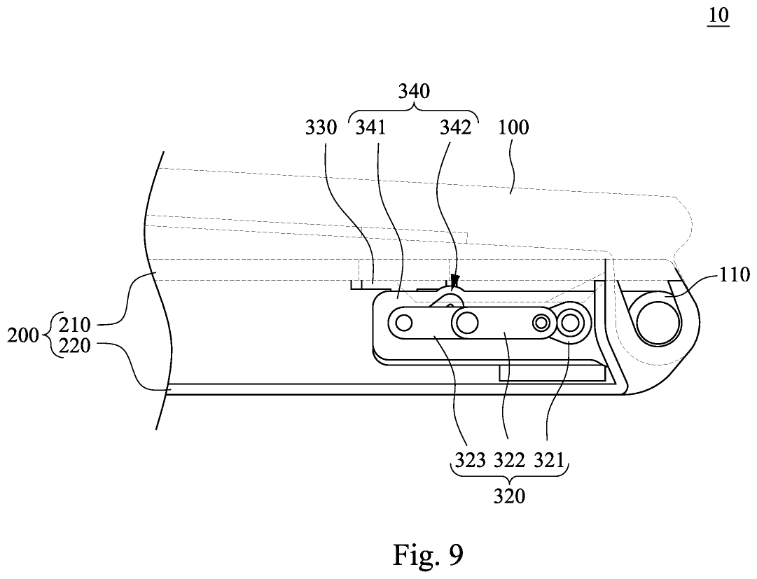

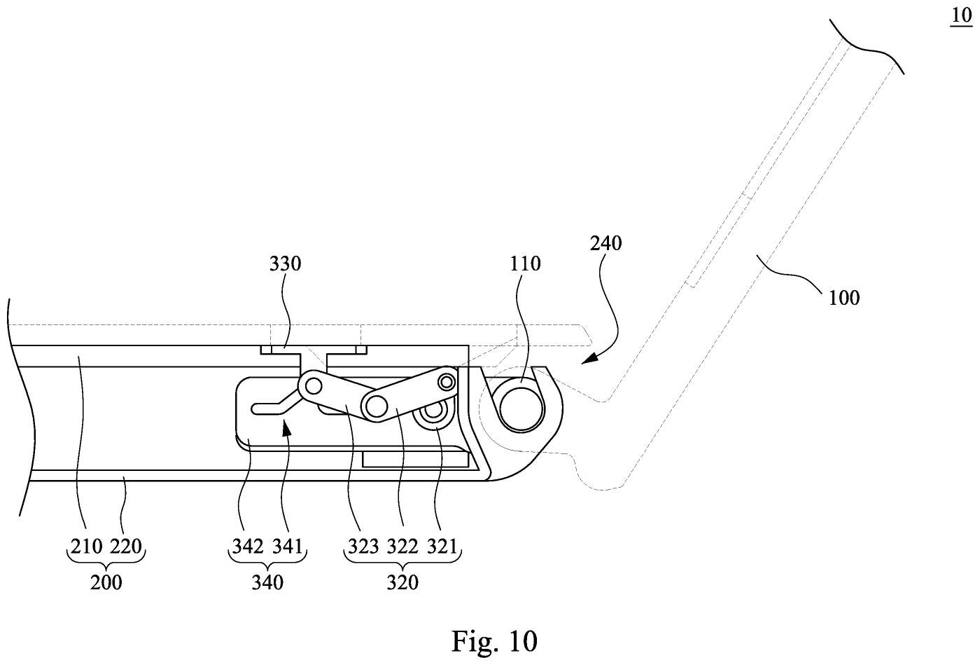

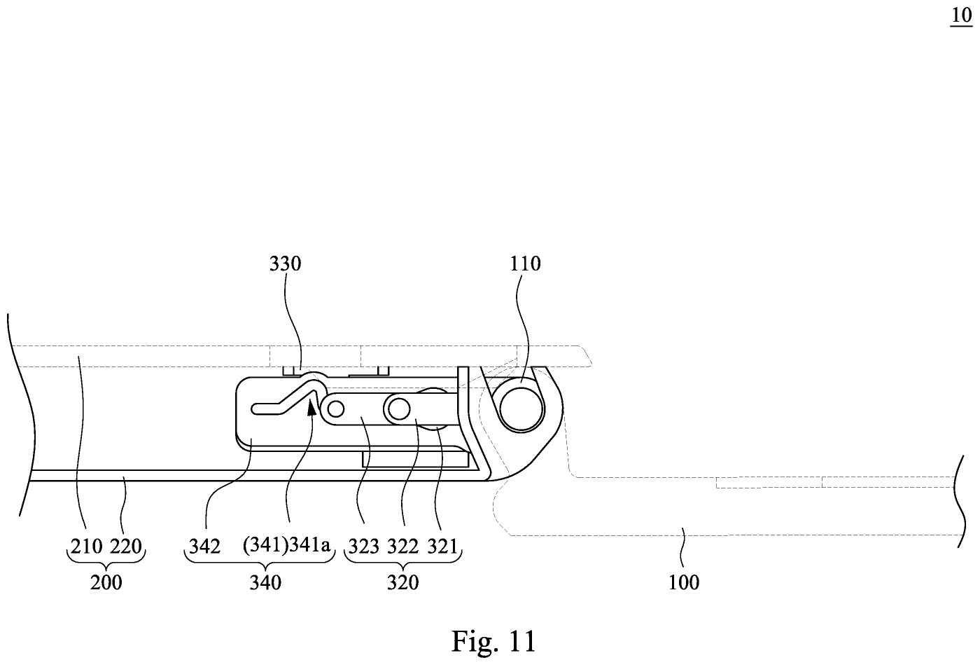

Reference is made to FIG. 1. FIG. 1 illustrates a schematic view of an electrical device 10 in accordance with some embodiments of the present invention. The electrical device 10 includes a laptop, but the present invention is not limited in this respect. The electrical device 10 includes a display screen 100 and a base 200, and the base 200 includes an upper shell 210 and a lower shell 220. The display screen 100 is configured to rotate with respect to the base 200 for driving the upper shell 210 to move toward the lower shell 220 and form an open state. The display screen 100 is also configured to rotate with respect to the base 200 for driving the upper shell 210 to separate from the lower shell 220 to form a closed state. As such, the base 200 is enabled to switches between the open state (shown in FIG. 10) and the closed state (shown in FIGS. 9 and 11). When the upper shell 210 moves away from the lower shell 220, the base 200 is in the open state and has an air flow path which is benefit for dissipating the heat accumulated in the electrical device 10. The following paragraphs introduce the internal structures and phenomena of the display screen 100 and the base 200.

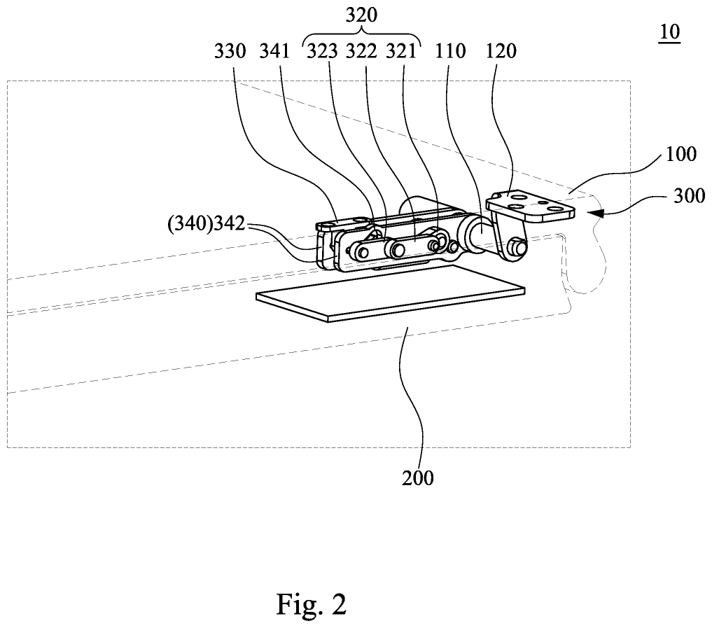

Reference is made to FIG. 2, which illustrates an internal view of the electrical device 10. In some embodiments of the present invention, the electrical device 10 further includes a driving structure 300, and the driving structure 300 is connected to the display screen 100 and partially located in the base 200. When the display screen 100 is rotating with respect to the base 200, the driving structure 300 drives the base 200 to switch between the open state and the closed state.

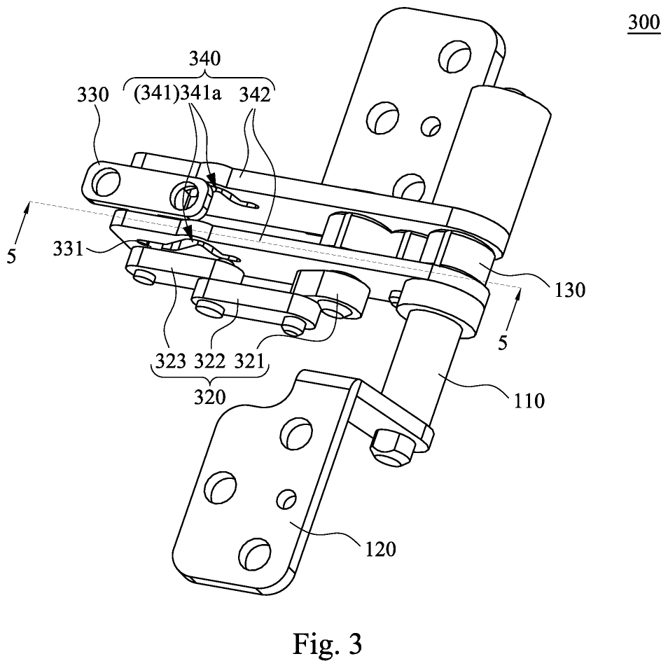

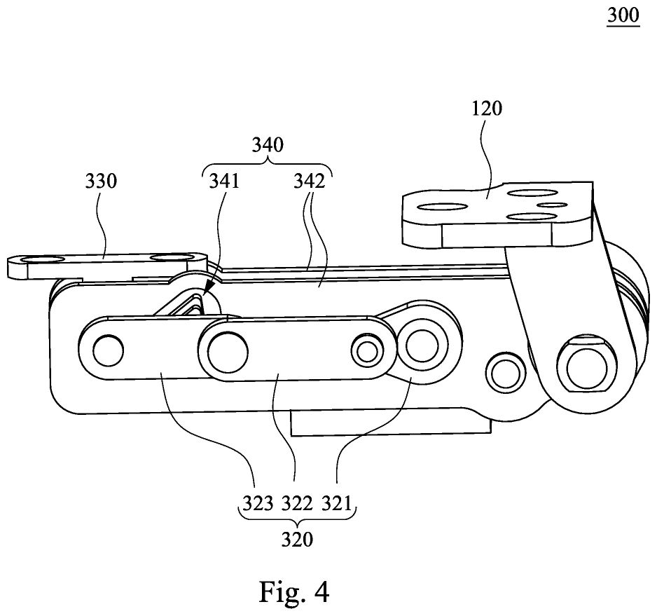

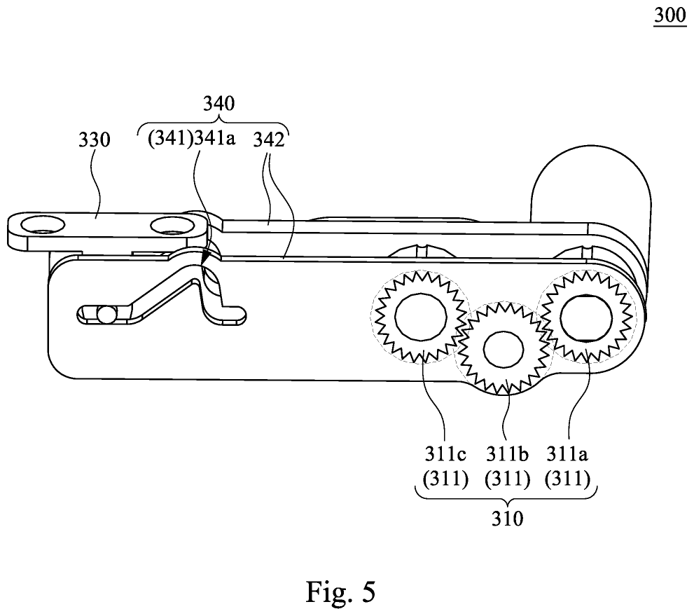

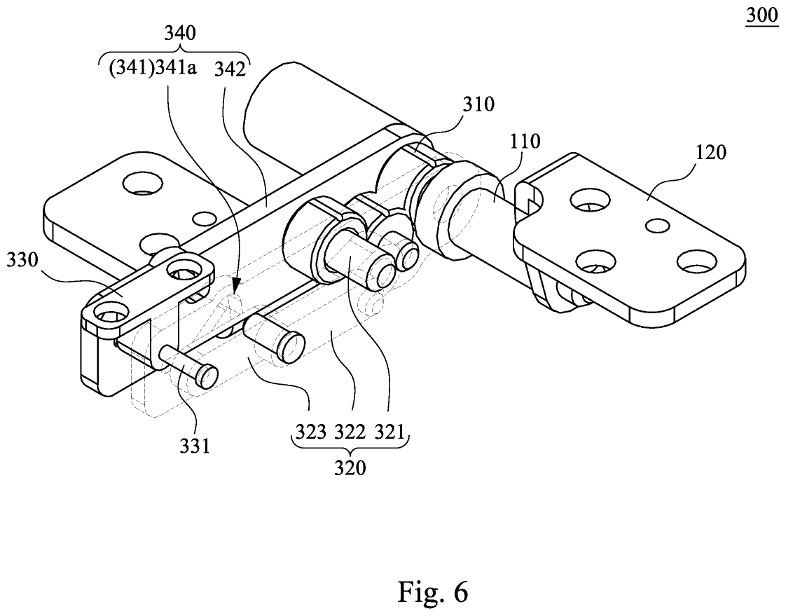

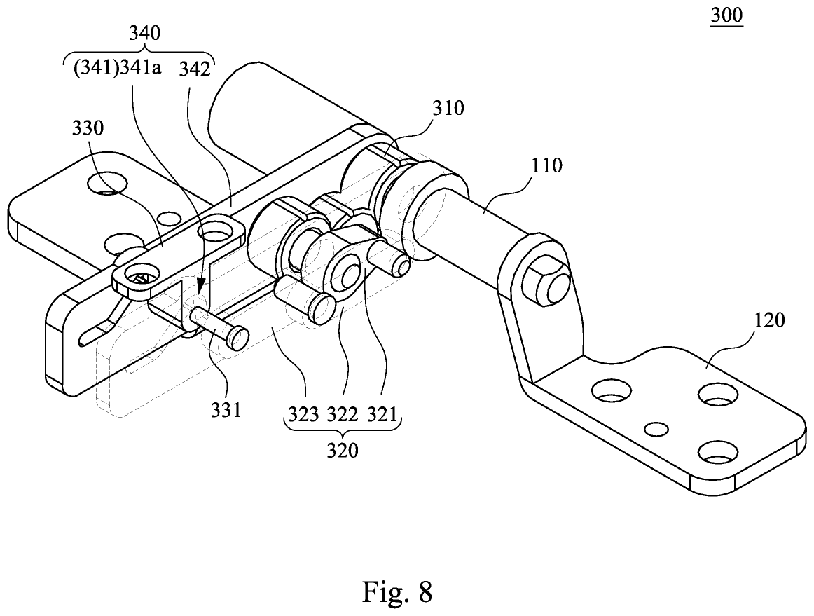

Reference is made to FIGS. 3-11. FIG. 3 illustrates a top view of the driving structure 300. FIG. 4 illustrates a side view of the driving structure 300. FIG. 5 illustrates a cross section view of the driving structure 300 taken from the line 5-5 in FIG. 3. FIGS. 6-8 illustrate schematic views of the driving structure 300, and the partial driving structure 300 is shown as transparent. FIGS. 9-11 respectively illustrate the acting relationship among the display screen 100, the upper shell 210, and the lower shell 220 of the base 200, in which the base 200 of the electrical device 10 is partially omitted for exposing the driving structure 300. In addition, FIGS. 6-8 respectively correspond to FIGS. 9-11. In some embodiments of the present invention, the driving structure 300 is connected to the display screen 100 and located between the upper shell 210 and the lower shell 220. When the display screen 100 is rotating with respect to the base 200, the driving structure 300 drives the upper shell 210 to move with respect to the lower shell 220, so as to enables the base 200 to switch between the open state and the closed state. Specifically, the driving structure 300 includes a gear assembly 310, a linkage assembly 320, and a pushing assembly 330. The gear assembly 310 is connected to a rotating shaft 110 of the display screen 100, and an extension arm 120 is rotatably connected to a side of the rotating shaft 110. Therefore, the display screen 100 is able to rotate with respect to the rotating shaft 110 through the extension arm 120. The linkage assembly 320 includes a rotating rod 321 and a moving rod 323, and the rotating rod 321 is connected to the gear assembly 310, such that the rotating rod 321 rotates for driving the moving rod 323 to move with respect to the rotating rod 321. In addition, the pushing assembly 330 is connected to the moving rod 323, and the pushing assembly 330 drives the upper shell 210 to move toward the lower shell 220 or move away from the lower shell 220 when the moving rod 323 is moving with respect to the rotating rod 321.

In some embodiments of the present invention, the gear assembly 310 includes at least three gears 311 which are sequentially engaged, in which the rotating shaft 110 of the display screen 100 and the rotating rod 321 of the linkage assembly 320 are respectively connected to two of the gears 311, and the display screen 100 and the rotating rod 321 has a same rotating direction. The gears 311 include a first gear 311a, a second gear 311b, and a third gear 311c, and the rotating shaft 110 of the display screen 100 is connected to the first gear 311a. The display screen 100 is configured for rotating and driving the first gear 311a to rotate, and the rotating rod 321 is connected to the third gear 311c and driven by the third gear 311c to rotate. In addition, the second gear 311b is engaged between the first gear 311a and the third gear 311c, and the first gear 311a is separated from the third gear 311c. Therefore, both the first gear 311a and the third gear 311c can keep rotating in the same rotating direction, and thus the display screen 100 has a rotating direction the same as a rotating direction of the rotating rod 321. The rotating rod 321 rotates for moving the moving rod 323. The moving rod 323 enables the pushing assembly 330 to further drive the upper shell 210 to move toward the lower shell 220 or move away from the lower shell 220 (referring to FIGS. 6-11) when the moving rod 323 is moving. As such, the gears 311 enable users to rotate the display screen 100 for driving the upper shell 210 to move toward the lower shell 220 or move away from the lower shell 220.

Moreover, the moving rod 323 of the linkage assembly 320 is driven by the rotating rod 321 to move the pushing assembly 330, and the linkage assembly 320 further includes a connecting rod 322. The connecting rod 322 has two ends which are rotatably connected to the rotating rod 321 and the moving rod 323, respectively, and thus the rotating rod 321 rotates to sequentially move the connecting rod 322 and the moving rod 323. The connecting rod 322 is located at the same side of the rotating rod 321 and the moving rod 323, and the connecting rod 322 controls the related positions of the rotating rod 321 and the moving rod 323. Therefore, the rotating rod 321 and the moving rod 323 can rotate and move in the same plane, and thus the rotating rod 321 efficiently moves the moving rod 323 via the connecting rod 322.

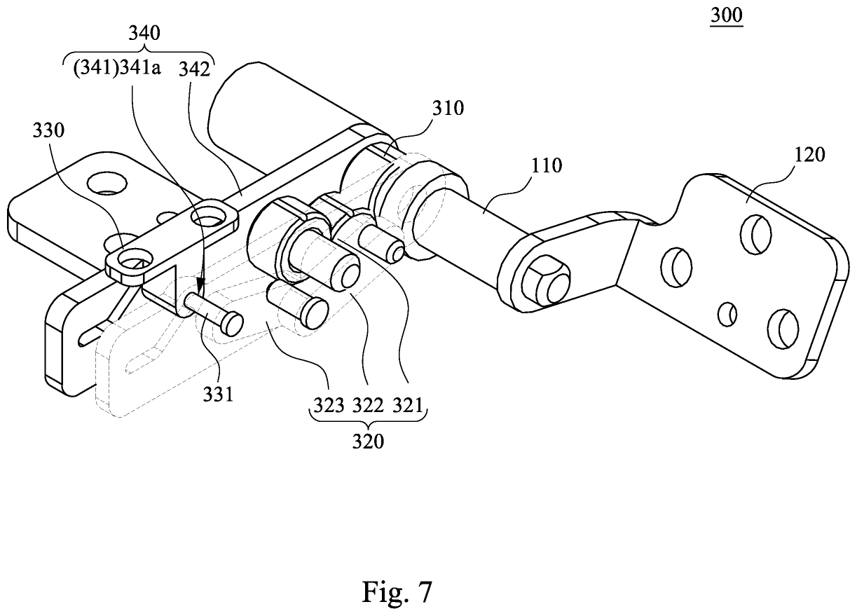

In some embodiments of the present invention, the moving rod 323 has an end rotatably connected to the connecting rod 322, and the moving rod 323 has another end connected to an extension portion 331 of the pushing assembly 330. Therefore, the linkage assembly 320 is driven by the gear assembly 310 to move the pushing assembly 330 via the moving rod 323. If the pushing assembly 330 drives the upper shell 210 to move toward the lower shell 220, the base 200 is in the closed state (shown in FIGS. 6, 8, 9 and 11). If the pushing assembly 330 drives the upper shell 210 to move away from the lower shell 220, the base 200 is in the open state (shown in FIGS. 7 and 10).

In some embodiments of the present invention, the pushing assembly 330 has an extension portion 331 movably connected to the guiding assembly 340. When the rotating rod 321 is rotating, the guiding assembly 340 guides the pushing assembly 330 to move upward or downward via the extension portion 331, so as to enables the upper shell 210 to move toward the lower shell 220 or move away from the lower shell 220. Specifically, the guiding assembly 340 has a guiding slot 341, and the extension portion 331 of the pushing assembly 330 is inserted into the guiding slot 341 of the guiding assembly 340. The guiding slot 341 which has a wavy-shaped portion wavily extends toward the rotating rod 321, and thus the guiding slot 341 extends upward and downward toward the rotating rod 321. For instance, the guiding slot 341 has an inverted V-shaped middle portion 341a. Therefore, when the moving rod 323 is driven by the rotating rod 321 to move toward the rotating rod 321 or move away from the rotating rod 321, the extension portion 331 of the pushing assembly 330 in the guiding slot 341 moves toward or moves away from the rotating rod 321 upward and downward through the inverted V-shaped middle portion 341a. The inverted V-shaped middle portion 341a enables the pushing assembly 330 to wavily move and drives the upper shell 210 to move toward the lower shell 220 or move away from the lower shell 220 (referring to FIGS. 6-11).

In some embodiments of the present invention, the guiding assembly 340 has two parallel and separated boards 342 and two guiding slots 341, and the two guiding slots 341 are respectively disposed on the two boards 342. The two guiding slots 341 are in mirror symmetry with respect to a center between the two boards 342. The extension portion 331 of the pushing assembly 330 is inserted into the two guiding slots 341, and the pushing assembly 330 is connected to the moving rod 323. Specifically, the pushing assembly 330 is disposed between the two boards 342, and the linkage assembly 320 is disposed on an outer side of one of the two boards 342. The pushing assembly 330 has two extension portions 331 respectively extend through the two guiding slots 341. The two guiding slots 341 are connected to pushing assembly 330 at two opposite sides of the pushing assembly 330, and thus the two guiding slots 341 can evenly support the pushing assembly 330. That is, the two guiding slots 341 let the pushing assembly 330 stably move with respect to the two boards 342.

Reference is made to FIG. 10. When the driving structure 300 is driving the upper shell 210 to partially separate from the lower shell 220, the base 200 is in the open state and has an air flow path 240. For instance, when a display surface of the display screen 100 and an upper surface of the base 200 form an angle from 75 degrees to 150 degrees, an end of the upper shell 210 is separated from an end of the lower shell 220. Therefore, the base 200 is in the open state and has the air flow path 240. Referring to FIGS. 9 and 11, when the driving structure 300 moves the upper shell 210 to cover the lower shell 220, the base 200 is in the closed state, in which the air flow path 240 (shown in FIG. 10) is closed. For instance, when a display surface of the display screen 100 and an upper surface of the base 200 form an angle smaller than 75 degrees or greater than 150 degrees, the upper shell 210 covers the lower shell 220, such that the base 200 is in the closed state for closing the air flow path 240 (shown in FIG. 10). In some embodiments of the present invention, the base 200 has an internal fan module (not shown), and the fan module can include an axial flow fan, a centrifugal fan, and a diagonal fan. The present invention is not limited in this respect. The driving structure 300 can be driven by the display screen 100 to make the upper shell 210 moving toward the lower shell 220 or moving away from the lower shell 220, and thus the base 200 can transform to have the air flow path 240 or close the air flow path 240. Therefore, when the electrical device 10 is operating, the air flow path 240 can provide the electrical device 10 and outstanding heat dissipation ability. That is, the driving structure 300 can be driven by the display screen 100 for selectively closing the air flow path 240, so as to prevent the electrical device 10 from being affected by dust and to protect the internal electrical elements in the electrical device 10.

In embodiments of the present invention, an electrical device includes a display screen and a base, and the display screen is rotatably with respect to the base and configured for driving the upper shell to separate from the lower shell or cover the lower shell. When the upper shell of the base is separated from the lower shell, the base has an air flow path. Therefore, the electrical device has outstanding heat dissipation ability. When the upper shell of the base covers the lower shell, the airflow path is closed to prevent the electrical device from affecting by dust.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. An electrical device, comprising:
a display screen;
a base, wherein the display screen is pivoted to and rotatably with respect to the base, and wherein the base comprises:
a lower shell; and
an upper shell movably connected to the lower shell; and
a driving structure connected to the display screen and partially disposed between the upper shell and the lower shell, wherein the driving structure is configured to move the upper shell to cover the lower shell to form a close state or separate from the lower shell to form an open state, so as to enable the base to switch between the close state and the open state;
wherein the driving structure comprises:
a gear assembly connected to a rotating shaft of the display screen;
a linkage assembly comprising a moving rod and a rotating rod which is connected to the gear assembly, wherein the rotating rod is configured to rotate for moving the moving rod; and
a pushing assembly connected to the moving rod, wherein the pushing assembly drives the upper shell to move toward the lower shell or move away from the lower shell when the moving rod is moving,
wherein the base is in the open state and has an air flow path when the driving structure moves the upper shell to separate from the lower shell.

2. (canceled)

3. The electrical device of claim 1, wherein the driving structure comprises:
a guiding assembly having a guiding slot, wherein the pushing assembly has an extension portion inserted into the guiding slot and connected to moving rod.

4. The electrical device of claim 3, wherein the guiding slot has a wavy-shaped portion.

5. The electrical device of claim 3, wherein the guiding slot has an inverted V-shaped middle portion.

6. The electrical device of claim 1, wherein the driving structure comprises:
a guiding assembly having two parallel boards and two guiding slots, wherein the two guiding slots are respectively disposed at the two boards in mirror symmetry, and wherein the pushing assembly has an extension portion inserted into the two guiding slots and connected to moving rod.

7. The electrical device of claim 6, wherein the pushing assembly is disposed between the two boards.

8. The electrical device of claim 1, wherein the gear assembly has at least three gears which are sequentially engaged, and wherein the rotating shaft of the display screen and the rotating rod are respectively connected to two of the gears, such that the display screen and the rotating rod has a same rotating direction.

9. (canceled)

10. The electrical device of claim 1, wherein the base is in the closed state for closing the air flow path when the driving structure moves the upper shell to cover the lower shell.
